(19) United States
(12) Patent Application Publication
(10) Pub. No.: US 2022/0385184 A1
(43) Pub. Date: Dec. 1, 2022

(54) POWER CONVERTER

(71) Applicant: Silergy Semiconductor Technology (Hangzhou) LTD, Hangzhou (CN)

(72) Inventors: Junyan Sun, Hangzhou (CN); Wang Zhang, Hangzhou (CN)

(21) Appl. No.: 17/743,646

(22) Filed: May 13, 2022

(30) Foreign Application Priority Data
May 26, 2021 (CN) 202110576662.3

(51) Int. Cl. H02M 3/158; H02M 3/07; H02M 1/00

(52) U.S. Cl. CPC H02M 3/158; H02M 3/07; H02M 1/0095

(57) ABSTRACT

A power converter can include a positive input terminal and a negative input terminal, configured to receive an input voltage; a positive output terminal and a negative output terminal, configured to generate an output voltage; a first power switch and a second power switch, sequentially coupled in series between the positive input terminal and a first node; a third power switch and a fourth power switch, sequentially coupled in series between a second node and the negative input terminal; a first energy storage element coupled between a common terminal of the first power switch and the second power switch and a common terminal of the third power switch and the fourth power switch; a first switched capacitor circuit coupled between the first node and the positive output terminal; and a second switched capacitor circuit coupled between the second node and the positive output terminal.

### RELATED APPLICATIONS

This application claims the benefit of Chinese Patent Application No. 202110576662.3, filed on May 26, 2021, which is incorporated herein by reference in its entirety.

### FIELD OF THE INVENTION

The present invention generally relates to the field of power electronics, and more particularly to power converters.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic diagram of an example power converter.

FIG. 2 is a schematic diagram of a first example power converter, in accordance with embodiments of the present invention.

FIG. 3 is a waveform diagram of example control signals for the first example power converter, in accordance with embodiments of the present invention.

FIGS. 4A-4B are schematic diagrams of equivalent circuits of the first example power converter in each operation interval, in accordance with embodiments of the present invention.

FIGS. 5A-5C are schematic diagrams of a second example power converter, in accordance with the embodiments of the present invention.

FIG. 6 is a schematic diagram of a third example power converter, in accordance with embodiments of the present invention.

FIG. 7 is a waveform diagram of example control signals for the third example power converter, in accordance with embodiments of the present invention.

FIGS. 8A-8B are schematic diagrams of equivalent circuits of the third example power converter in each operation interval, in accordance with embodiments of the present invention.

FIGS. 9A-9C are schematic diagrams of a fourth example power converter, in accordance with embodiments of the present invention.

FIG. 10 is a schematic diagram of a fifth example power converter, in accordance with embodiments of the present invention.

FIG. 11 is a waveform diagram of example control signals for the fifth example power converter, in accordance with embodiments of the present invention.

FIGS. 12A-12B are schematic diagrams of equivalent circuits of the fifth example power converter in each operation interval, in accordance with embodiments of the present invention.

FIG. 13 is a schematic diagram of a sixth example power converter, in accordance with embodiments of the present invention.

FIG. 14 is a waveform diagram of example control signals for the sixth example power converter, in accordance with embodiments of the present invention.

FIGS. 15A-15C are schematic diagrams of equivalent circuits of the sixth example power converter in each operation interval, in accordance with embodiments of the present invention.

FIGS. 16A-16C are schematic diagrams of a seventh example power converter, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

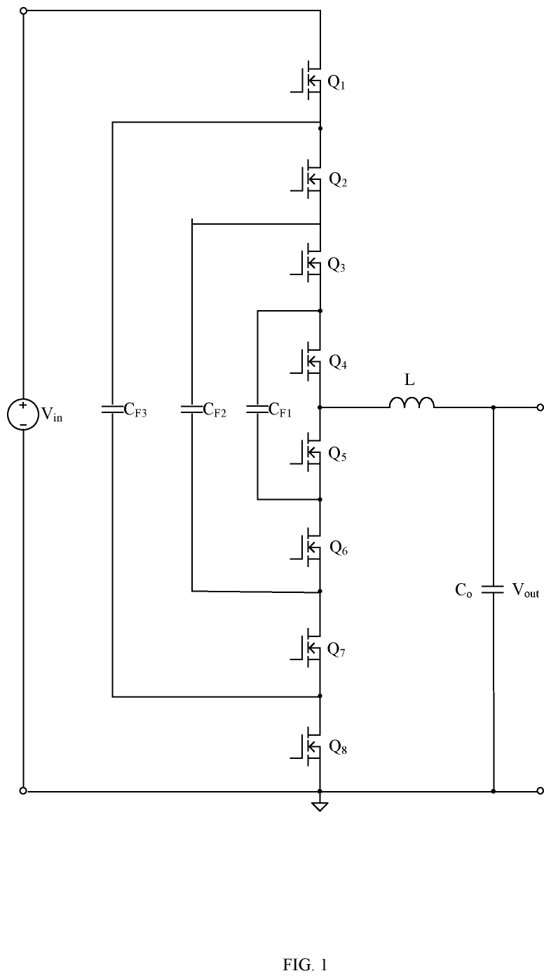

With the development of society, energy shortage has become a primary problem. Power electronics technology has developed by leaps and bounds in recent years, and efficient power converters are an indispensable part of energy utilization. Referring now to FIG. 1, shown is a schematic diagram of an example power converter. The high-efficiency power converter can include power switches Q1-Q8, flying capacitors C_{F1}-C_{F3}, inductor L, and output capacitor Co. Power switches Q1-Q8 can connect in series between the input high potential terminal of the power converter and a ground potential to receive input voltage Vin. Flying capacitor C_{F3} can be coupled between a common terminal of power switches Q1 and Q2 and a common terminal of power switches Q7 and Q8, flying capacitor C_{F2} can be coupled between a common terminal of power switches Q2 and Q3 and a common terminal of power switches Q6 and Q7, and flying capacitor C_{F1} can be coupled between a common terminal of power switches Q3 and Q4 and a common terminal of power switches Q5 and Q6. One terminal of inductor L can be coupled to a common terminal of power switches Q4 and Q5, and the other terminal of inductor L may be coupled to the output high potential terminal of the power converter. Further, output capacitor Co can be coupled between the output high potential terminal of the power converter and the ground potential to obtain output voltage Vout. The power converter can efficiently realize the voltage conversion of 4:1, that is, the ratio of input voltage Vin to output voltage Vout is 4:1, but it requires 8 power switches coupled in series, which makes the implementation of the driving circuit more complicated, so the number of power switches coupled in series should be minimized.

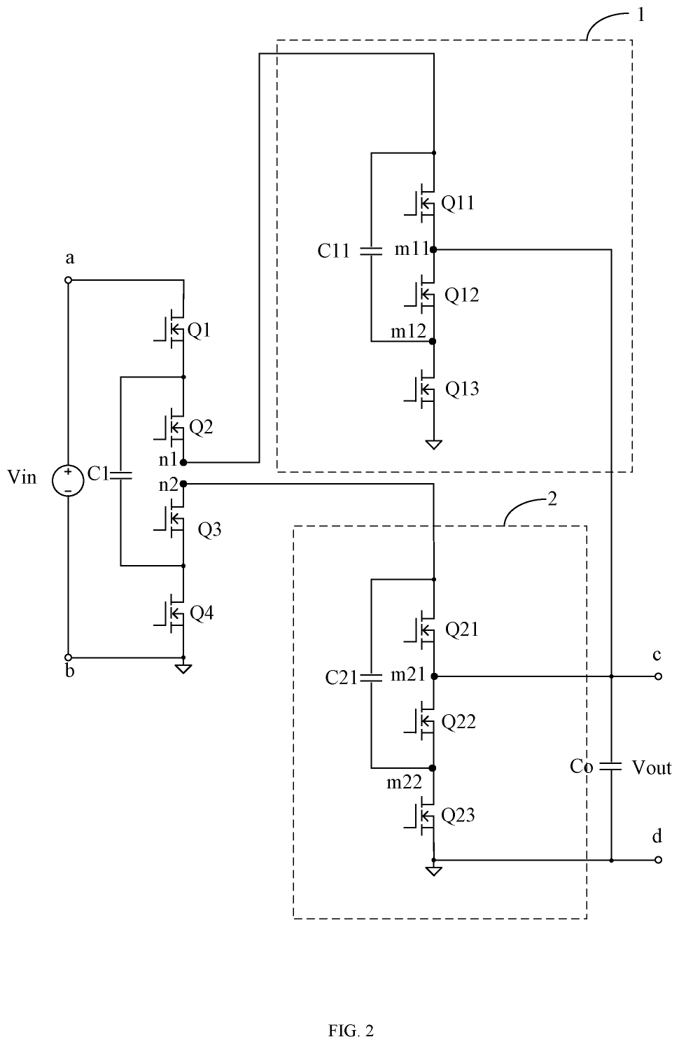

Referring now to FIG. 2, shown is a schematic diagram of a first example power converter, in accordance with embodiments of the present invention. The power converter can include positive input terminal a, negative input terminal b, positive output terminal c, negative output terminal d, power switches Q1, Q2, Q3, and Q4, energy storage element C1, and switched capacitor circuits 1 and 2. For example, positive input terminal a and negative input terminal b can receive input voltage Vin. Positive output terminal c and negative output terminal d may generate output voltage Vout. Power switches Q1 and Q2 can be sequentially coupled in series between positive input terminal a and first node n1. Power switches Q3 and Q4 can be sequentially coupled in series between second node n2 and negative input terminal b. Energy storage element C1 can be coupled between the common terminal of power switches Q1 and Q2 and the common terminal of power switches Q3 and Q4. Switched capacitor circuit 1 can be coupled between first node n1 and positive output terminal c. Switched capacitor circuit 2 can be coupled between second node n2 and positive output terminal c. A load can be coupled between positive output terminal c and negative output terminal d. In addition, there may be no direct physical connection between first node n1 and second node n2.

Further, the duty ratios of power switches Q1, Q2, Q3, and Q4 can be the same. In addition, the switching states of power switches Q1 and Q3 may be the same, the switching states of power switches Q2 and Q4 may be the same, and there can be a phase difference between power switches Q1 and Q2. In this example, a first terminal of switched capacitor circuit 1 can be coupled to first node n1, and a second terminal of switched capacitor circuit 1 may be coupled to positive output terminal c. A first terminal of switched capacitor circuit 2 can be coupled to second node n2, and a second terminal of switched capacitor circuit 2 may be coupled to positive output terminal c.

In this example, switched capacitor circuit 1 can include three fifth power switches Q11 to Q13 connected in series and one first flying capacitor C11. Here, fifth power switches Q11 to Q13 can be sequentially connected in series between first node n1 and the ground potential to form two first intermediate nodes m11 and m12, and first flying capacitor C11 may be coupled between first node n1 and the 2^{nd} first intermediate node m12, where the second terminal of the switched capacitor circuit 1 is configured as the 1^{st} first intermediate node m11. Switched capacitor circuit 2 can include three sixth power switches Q21 to Q23 connected in series and one second flying capacitor C21. Here, sixth power switches Q21 to Q23 can connect in series between second nodes n2 and the ground potential to form two second intermediate nodes m21 and m22, and the second flying capacitor C21 can be coupled between the second node n2 and the 2^{nd} second intermediate node m22, where the second terminal of Switched capacitor circuit 2 is configured as the 1^{st} second intermediate node m21. Optionally, the power converter can also include output capacitor Co, which can be coupled between positive output terminal c and negative output terminal d, and can connect in parallel with the load to filter output voltage Vout.

In this particular example, switched capacitor circuits 1 and 2 are switched capacitor circuits in a step-down form. In other examples, switched capacitor circuits 1 and 2 may be switched capacitor circuits in a step-up form, such that the power converter can efficiently perform the step-up function, which is not limited by the present disclosure. In addition, in the following examples, switched capacitor circuits 1 and 2 may also be described by taking the step-down switched capacitor circuits as one particular example.

In this example, the power converter can also include a control circuit, which can control the switching states of the respective power switches, such that the switching states of power switches Q1 and Q3 are the same, the switching states of power switches Q2 and Q4 are the same, and the duty ratios of first to fourth power switches are D, where D=½. In addition, power switches Q1 and Q2 can be under phase-shifted control, and the phase difference between the turn-on moments of power switch Q1 (or power switch Q3) and power switch Q2 (or power switch Q4) is 180°. Further, the phase difference between the turn-on moments of the 1^{st} sixth power switches Q21 and Q3 is 180°, the switching states of the 2^{nd} sixth power switch Q22 and the 1^{st} sixth power switch Q21 are complementary, and the switching states of the 3^{rd} sixth power switches Q23 and Q3 are complementary. For example, phase difference between the turn-on moments of the 1^{st} fifth power switch Q11 and power switch Q2 is 180°, the switching states of the 2^{nd} fifth power switch Q12 and the 1^{st} fifth power switch Q11 are complementary, and the switching states of the 3^{rd} fifth power switch Q13 and power switch Q2 are complementary.

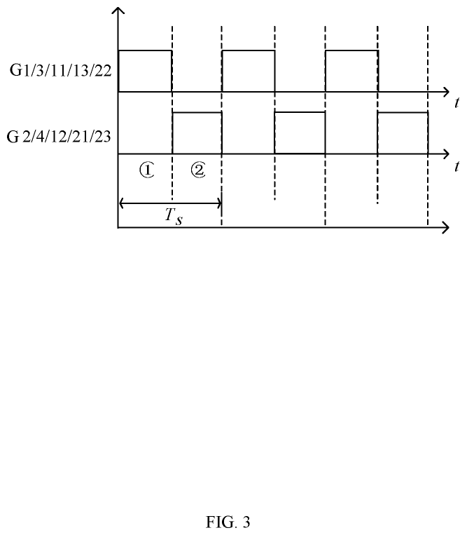

Referring now to FIG. 3, shown is a waveform diagram of example control signals for the first example power converter, in accordance with embodiments of the present invention. In this example, G1/3/11/13/22 is the control signal for power switches Q1, Q3, Q11, Q13, and Q22, and G2/4/12/21/23 is the control signal for power switches Q2, Q4, Q12, Q21, and h Q23.

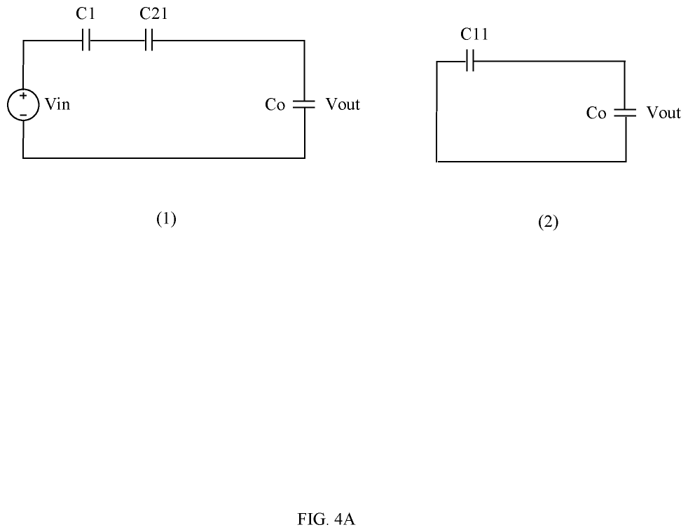

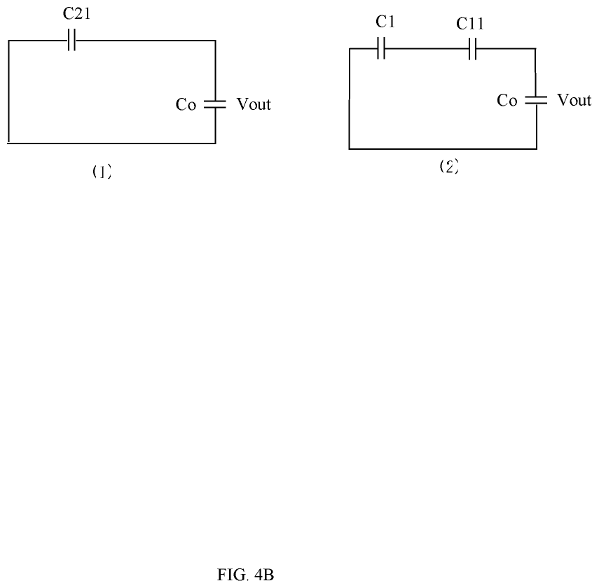

Referring now to FIGS. 4A-12B, shown are schematic diagrams of equivalent circuits of the first example power converter in each operation interval, in accordance with embodiments of the present invention. The working process of the first example power converter will be explained with reference to FIGS. 3 and 4A-4B. As shown in FIG. 3, in the operation interval \textcircled{1}, control signal G1/3/11/13/22 is at a high level, and thus power switch Q1, power switch Q3, fifth power switch Q11, fifth power switch Q13, and sixth power switch Q22 are turned on. At this time, the first operation loop is Vin-Q1-C1-Q3-C21-Q22-load-Vin, and the equivalent circuit diagram is shown in (1) of FIG. 4A. That is, input voltage Vin supplies power to the load through energy storage element C1 and second flying capacitor C21. The second operation loop is C11-Q11-load-Q13-C11, and the equivalent circuit diagram is shown in (2) of FIG. 4A; that is, first flying capacitor C11 supplies power to the load.

In the operation interval \textcircled{2}, control signal G2/4/12/21/23 is at a high level, and thus power switch Q2, power switch Q4, fifth power switch Q12, sixth power switch Q21, and sixth power switch Q23 are turned on. At this time, the first operation loop is C21-Q21-load-Q23-C21, and the equivalent circuit diagram is shown in (1) of FIG. 4B; that is, second flying capacitor C21 supplies power to the load. The second operation loop is C1-Q2-C11-Q12-load-Q4-C1, and the equivalent circuit diagram is shown in (2) of FIG. 4B; that is, energy storage element C1 supplies power to the load through first flying capacitor C11.

The operation intervals \textcircled{1}˜\textcircled{2} form one operation cycle Ts. In this example, by controlling the switching state of each power switch, output voltage Vout is controlled to be equal to ¼ of input voltage Vin; that is, Vout=¼*Vin, such that the power converter can efficiently complete the voltage conversion of 4:1. In this example, only three power switches are coupled in series in the power converter; that is, the number of power switches coupled in series is reduced, such that the realization of the driving circuit can be simpler, and the circuit cost can be reduced.

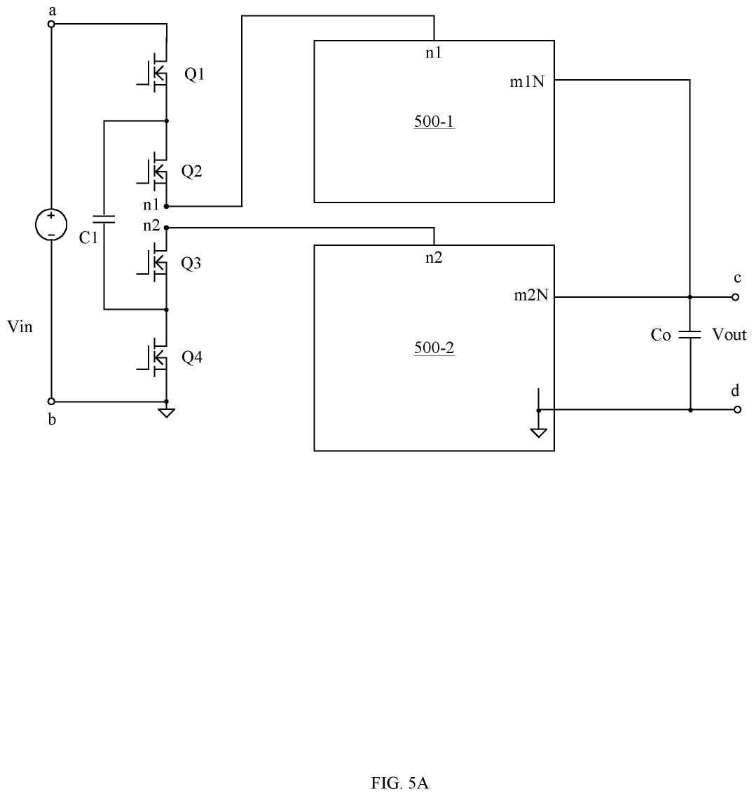

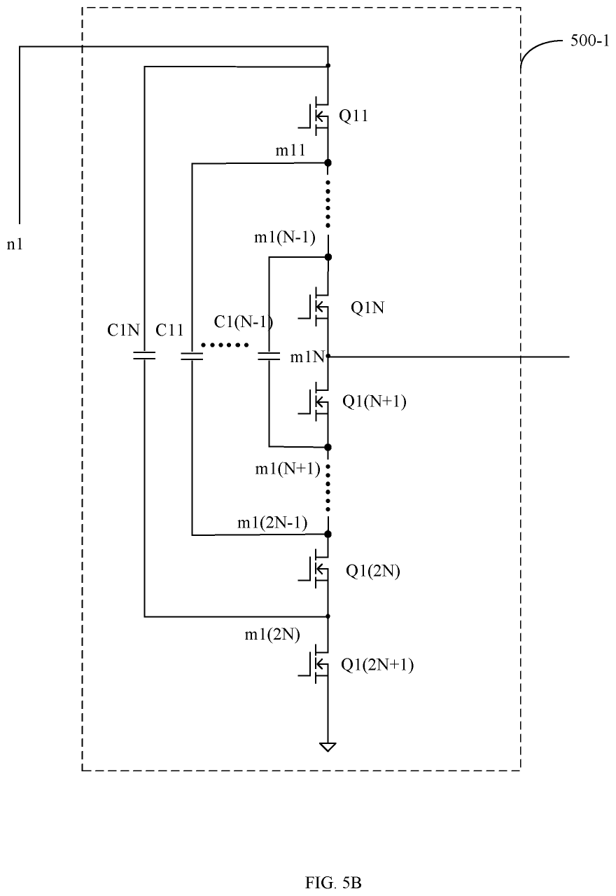

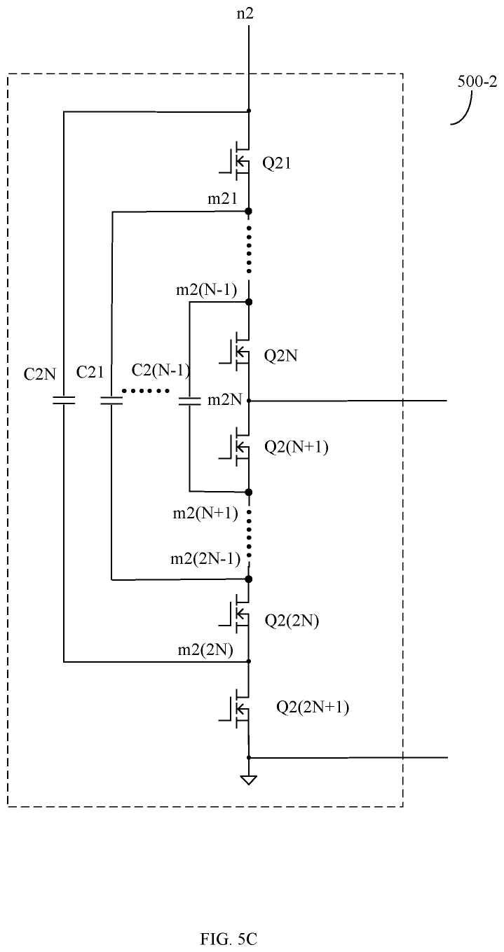

Referring now to FIGS. 5A-5C, shown are schematic diagrams of a second example power converter, in accordance with embodiments of the present invention. The difference from the first example is that the structures of switched capacitor circuits 1 (500-1) and 2 (500-2) are different. For example, switched capacitor circuit 1 can include 2N+1 fifth power switches Q11 to Q1(2N+1) connected in series and N first flying capacitors C11 to C1N. Fifth power switches Q11˜Q1(2N+1) may be sequentially connected in series between first node n1 and the ground potential to form 2N first intermediate nodes m11˜m1(2N) the Nth first flying capacitor C1N is coupled between first node n1 and the 2Nth first intermediate node m1(2N), and the rth first flying capacitor C1r is coupled between the rth first intermediate node m1r and the (2N−r)th first intermediate node m1(2N−r), where the second terminal of switched capacitor circuit 1 can be configured as the Nth first intermediate node m1N, and r is less than N, N is an integer greater than or equal to 1.

Switched capacitor circuit 2 can include 2N+1 sixth power switches Q21 to Q2(2N+1) connected in series and N second flying capacitors C21 to C2N. The 2N+1 sixth power switches Q21˜Q2(2N+1) may be sequentially connected in series between second node n2 and the ground potential to form 2N second intermediate nodes m21˜m2(2N), and the Nth second flying capacitor C2N is coupled between second node n2 and the 2Nth second intermediate node m2(2N), the rth second flying capacitor C2r is coupled between the rth second intermediate node m2r and the (2N−r)th second intermediate node m2 (2N−r), where the second terminal of Switched capacitor circuit 2 is configured as the Nth second intermediate node m2N, and r is less than N, N is an integer greater than or equal to 1.

In this example, the power converter can also include a control circuit, and the control circuit is configured to control the switching states of the respective power switches, so that: the switching states of power switches Q1 and Q3 can be the same, the switching states of power switches Q2 and Q4 may be the same, and the duty ratios of the first to fourth power switches can be equal to D, where D=1/(N+1). Further, power switches Q1 and Q2 may be under phase-shifted control, and the phase difference between the turn-on moments of power switch Q1 (or power switch Q3) and power switch Q2 (or power switch Q4) is 360°/(N+1).

Further, the duty ratios of power switch Q1, power switch Q3, the first N fifth power switches (e.g., fifth power switches Q11 to Q1N), power switch Q2, power switch Q4, and the first N sixth power switches (e.g., sixth power switches Q21 to Q2N) can be the same, and are equal to 1/(N+1), and power switch Q3 and the 1^{st} sixth power switch Q21 to the Nth sixth power switch Q2N may be under phase-shifted control, such that the phase difference between the turn-on moments of every two adjacent power switches in power switch Q3 and the 1^{st} sixth power switch Q21 to the Nth sixth power switch Q2N is 360°/(N+1). That is, the phase difference between the turn-on moments of power switch Q3 and the 1^{st} sixth power switch Q21 is 360°/(N+1), the phase difference between the turn-on moments of the 1^{st} sixth power switch Q21 and the 2^{nd} sixth power switch Q22 is 360°/(N+1), . . . , and the phase difference between the turn-on moments of the (N−1)th sixth power switch Q2(N−1) and the Nth sixth power switch Q2N is 360°/(N+1). The switching states of the (2N+1)th sixth power switch Q2(2N+1) and power switch Q3 can be complementary, and the switching states of the (2N−n+1)th sixth power switch Q2(2N−n+1) and the nth sixth power switch Q2n are complementary, where n is less than or equal to N.

Similarly, power switch Q2 and the 1^{st} fifth power switch Q11 to the Nth fifth power switch Q1N may be under phase-shifted control, such that the phase difference between the turn-on moments of every two adjacent power switches in power switch Q2 and the 1^{st} fifth power switch Q11 to the Nth fifth power switch Q1N is 360°/(N+1). The switching states of the (2N+1)th fifth power switch Q1(2N+1) and power switch Q2 can be complementary, and the switching states of the (2N−n+1)th fifth power switch Q1(2N−n+1) and the nth fifth power switch Q1n are complementary, where n is less than or equal to N. In this example, output voltage Vout is equal to 1/(2*(N+1)) of input voltage Vin, that is, Vout=1/(2*(N+1))*Vin, where N is greater than or equal to 1. Thus, the power converter can efficiently complete the voltage conversion of 2*(N+1): 1. In this example, the number of power switches coupled in series is reduced, such that the realization of the driving circuit can be made simpler and circuit costs can be reduced.

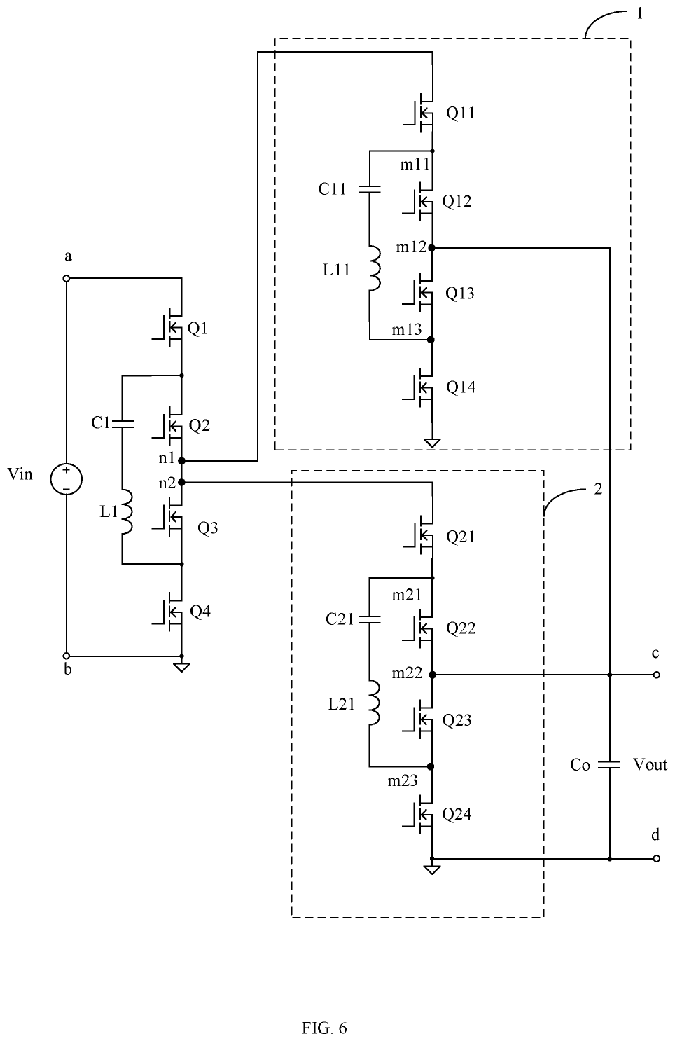

Referring now to FIG. 6, shown is a schematic diagram of a third example power converter, in accordance with embodiments of the present invention. The difference from the first example is that: first node n1 and second node n2 are connected together; the power converter can also include magnetic element L1, where energy storage element C1 and magnetic element L1 are coupled in series between the common terminal of power switches Q1 and Q2 and the common terminal of power switches Q3 and Q4; and the structures of switched capacitor circuits 1 and 2 are different. For example, switched capacitor circuit 1 can include four fifth power switches Q11 to Q14, one first flying capacitor C11, and one first inductor L11 connected in series. Fifth power switches Q11 to Q14 can be sequentially connected in series between first node n1 and the ground potential to form three first intermediate nodes m11, m12 and m13; and first flying capacitor C11 and first inductor L11 are connected in series between the 1^{st} first intermediate node m11 and the 3^{rd} first intermediate node m13, where the second terminal of switched capacitor circuit 1 can be configured as the 2^{nd} first intermediate node m12. Switched capacitor circuit 2 can include four sixth power switches Q21 to Q24, one second flying capacitor C21 and one second inductor L21. Sixth power switches Q21 to Q24 may be sequentially connected in series between second node n2 and the ground potential to form three second intermediate nodes m21, m22 and m23; and second flying capacitor C21 and second inductor L21 can connect in series between the 1^{st} second intermediate node m21 and the 3^{rd} second intermediate node m23, where the second terminal of Switched capacitor circuit 2 is configured as the 2^{nd} second intermediate node m22.

In this example, the power converter can also include a control circuit, and the control circuit can control the switching states of the respective power switches, so that: the switching states of power switches Q1 and Q3 are the same, the switching states of power switches Q2 and Q4 are the same, and the duty ratios of the first to fourth power switches are D, where D=½. Further, power switches Q1 and Q2 are under phase-shifted control, and the phase difference between the turn-on moments of power switch Q1 (or power switch Q3) and power switch Q2 (or power switch Q4) is 180°. The switching states of the 1^{st} sixth power switch Q21 and power switch Q3 may be the same, and the phase difference between the turn-on moments of the 2^{nd} sixth power switch Q22 and the 1^{st} sixth power switch Q21 is 180°, the switching states of the 3^{rd} sixth power switch Q23 and the 2^{nd} sixth power switch Q22 are complementary, and the switching states of the 4^{th} sixth power switch Q24 and the 1^{st} sixth power switch Q21 are complementary; the switching states of the 1^{st} fifth power switch Q11 and power switch Q2 are the same, and the phase difference between the turn-on moments of the 2^{nd} fifth power switch Q12 and the 1^{st} fifth power switch Q11 is 180°, the switching states of the 3^{rd} fifth power switch Q13 and the 2^{nd} fifth power switch Q12 can be complementary, and the switching states of the 4^{th} fifth power switch Q14 and the 1^{st} fifth power switches Q11 may be complementary.

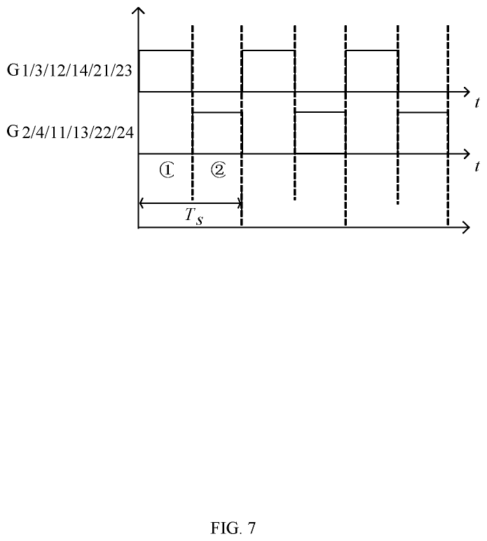

Referring now to FIG. 7, shown is a waveform diagram of example control signals for the third example power converter, in accordance with embodiments of the present invention. G1/3/12/14/21/23 is the control signal for power switch Q1, power switch Q3, fifth power switch Q12, fifth power switch Q14, sixth power switch Q21 and sixth power switch Q23, and G2/4/11/13/22/24 is the control signal for power switch Q2, power switch Q4, fifth power switch Q11, fifth power switch Q13, sixth power switch Q22 and sixth power switch Q24.

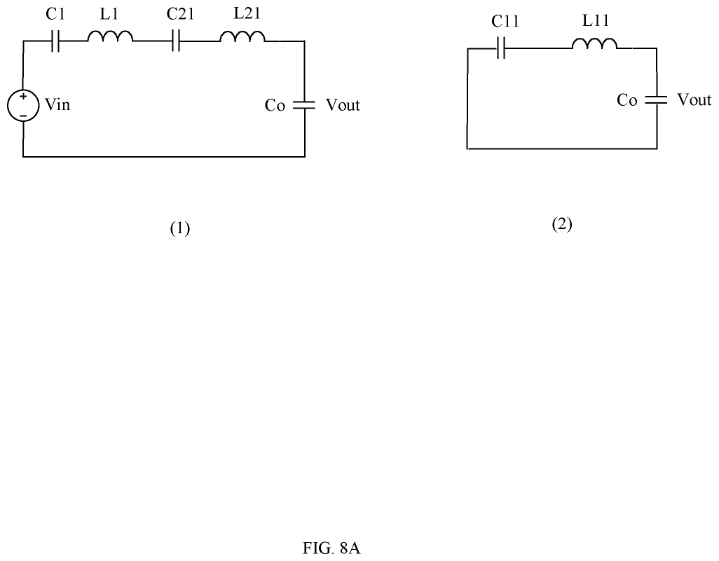

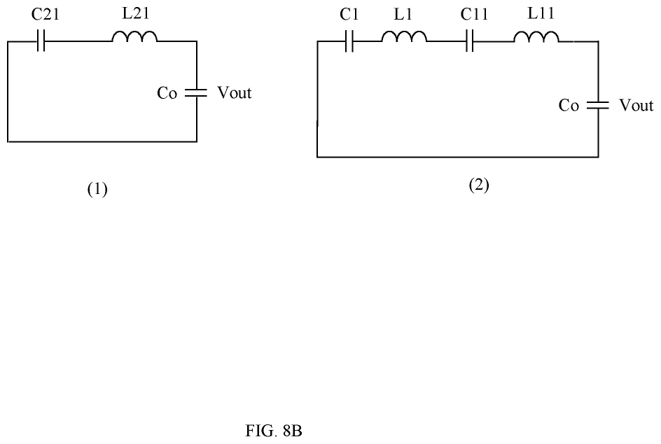

Referring now to FIGS. 8A-8B, shown are schematic diagrams of equivalent circuits of the third example power converter in each operation interval, in accordance with embodiments of the present invention. The working process of the third example power converter will be explained with reference to FIG. 7 and FIGS. 8A-8B. As shown in FIG. 7, in the operation interval \textcircled{1}, control signal G1/3/12/14/21/23 is at a high level, and thus power switch Q1, power switch Q3, fifth power switch Q12, fifth power switch Q14, sixth power switch Q21, and sixth power switch Q23 are turned on. At this time, the first operation loop is Vin-Q1-C1-L1-Q3-Q21-C21-L21-Q23-load-Vin, and the equivalent circuit diagram is shown in (1) of FIG. 8A; that is, input voltage Vin supplies power to the load through energy storage element C1, magnetic element L1, second flying capacitor C21, and second inductor L21. The second operation loop is C11-Q12-load-Q14-L11-C11, and the equivalent circuit diagram is shown in (2) of FIG. 8A; that is, first flying capacitor C11 supplies power to the load through first inductor L11. Furthermore, in the operation interval \textcircled{1}, the resonant frequency of the equivalent capacitor and the equivalent inductor in the first operation loop is controlled to be equal to the resonant frequency of the capacitor and inductor in the second operation loop, and the resonant frequency is controlled to be equal to the working frequency of the power converter, such that the power converter works in a resonant state in the operation interval \textcircled{1}. In one example, when the capacitance values of energy storage element C1, first flying capacitor C11 and second flying capacitor C21 are equal, and the inductance values of magnetic element L1, first inductor L11 and second inductor L21 are equal; that is, C1=C11=C21, and L1=L11=L21, the resonance frequency of the equivalent capacitor and the equivalent inductor in the first operation loop is equal to that in the second operation loop in the operation interval \textcircled{1}.

In the operation interval \textcircled{2}, control signal G2/4/11/13/22/24 is at the high level, and thus power switch Q2, power switch Q4, fifth power switch Q11, fifth power switch Q13, sixth power switch Q22, and sixth power switch Q24 are turned on. At this time, the first operation loop is C21-Q22-load-Q24-L21-C24, and the equivalent circuit diagram is shown in (1) of FIG. 8B; that is, second flying capacitor C21 supplies power to the load through second inductor L21. The second operation loop is C1-Q2-Q11-C11-L11-Q13-load-Q4-L1-C1, and the equivalent circuit diagram is shown in (2) of FIG. 8B; that is, energy storage element C1 supplies power to the load through first flying capacitor C11, first inductor L11 and magnetic element L1. Also, in the operation interval \textcircled{2}, the resonant frequency of the capacitor and inductor in the first operation loop is controlled to be equal to the resonant frequency of the equivalent capacitor and inductor in the second operation loop, and the resonant frequency is controlled to be equal to the working frequency of the power converter, such that the power converter works in a resonant state in the operation interval \textcircled{2}. In one example, when the capacitance values of energy storage element C1, first flying capacitor C11 and second flying capacitor C21 are equal, and the inductance values of magnetic element L1, first inductor L11, and second inductor L21 are equal, that is, C1=C11=C21, and L1=L11=L21, the resonance frequency of the capacitor and inductor in the first operation loop is equal to that in the second operation loop in the operation interval \textcircled{2}. Furthermore, when the capacitance values of energy storage element C1, first flying capacitor C11 and second flying capacitor C21 can be equal, and the inductance values of magnetic element L1, first inductor L11 and second inductor L21 are equal; that is, C1=C11=C21, and L1=L11=L21, the resonance frequency of the power converter remains unchanged in the operation intervals \textcircled{1} and \textcircled{2}, and the current waveform is symmetrical.

The operation intervals \textcircled{1}˜\textcircled{2} may form one operation cycle Ts. In this example, by controlling the switching state of each power switch, output voltage Vout is equal to ¼ of input voltage Vin, that is, Vout=¼*Vin, that is, the power converter can efficiently complete the voltage conversion of 4:1. In this example, only four power switches are coupled in series in the power converter; that is, the number of power switches coupled in series is reduced, such that the realization of the driving circuit can be simpler, and the circuit cost can be reduced. Furthermore, in this example, the power converter works in the resonant state, so the power switches in the power converter works in the zero-current-switching (ZCS) state, and the switching loss is reduced. In this example, the current peak in the first operation loop and the second operation loop in each operation interval is reduced, such that the current ripple is reduced, the switching loss is reduced, the efficiency of the power converter is improved, and the EMI interference is reduced.

In other examples, the power converter may not include magnetic element L1, such that the first operation loop in the operation interval \textcircled{1} and the second operation loop in the operation interval \textcircled{2} do not include magnetic element L1. Other working processes and control methods can be the same as those in this example. When the power converter does not include magnetic element L1, e.g., when the capacitance values of first flying capacitor C11 and second flying capacitor C21 are equal, the capacitance of energy storage element C1 is much larger than that of first flying capacitor C11, and the inductance values of first inductor L11 and second inductor L21 are equal, that is, when C1>>C11=C21, and L11=L21, the resonant frequency of the equivalent capacitor and equivalent inductor in the first operation loop is controlled to be equal to the resonant frequency of the equivalent capacitor and equivalent inductor in the second operation loop in the operation interval \textcircled{1} and operation interval \textcircled{2}, respectively. The resonant frequency of the power converter in the operation interval \textcircled{1} and operation interval \textcircled{2} remains unchanged, and the current waveform is symmetrical.

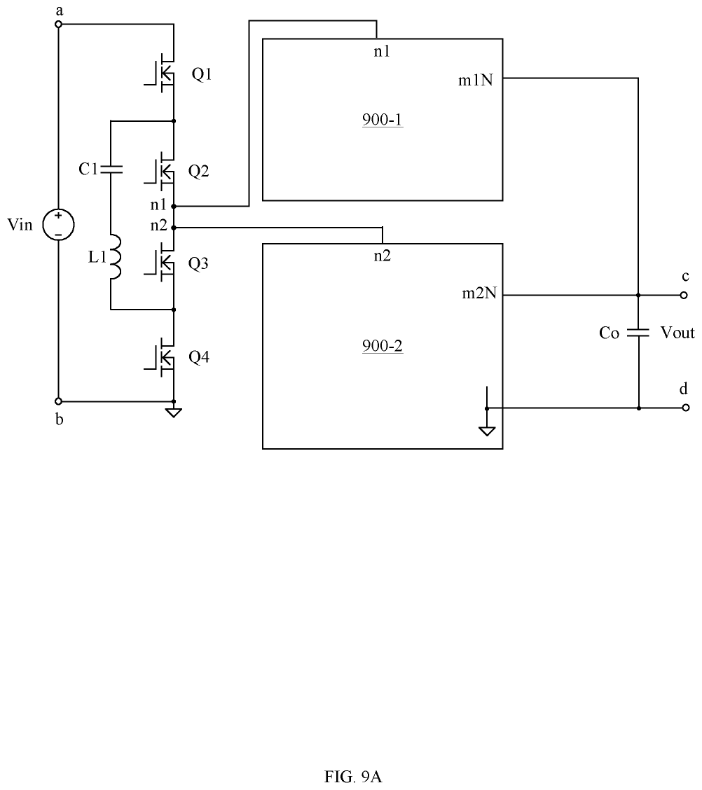

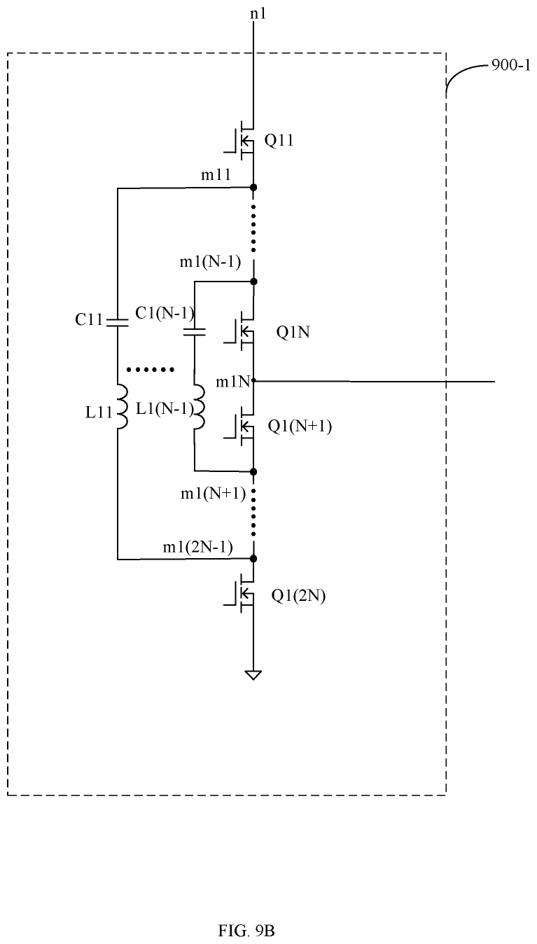

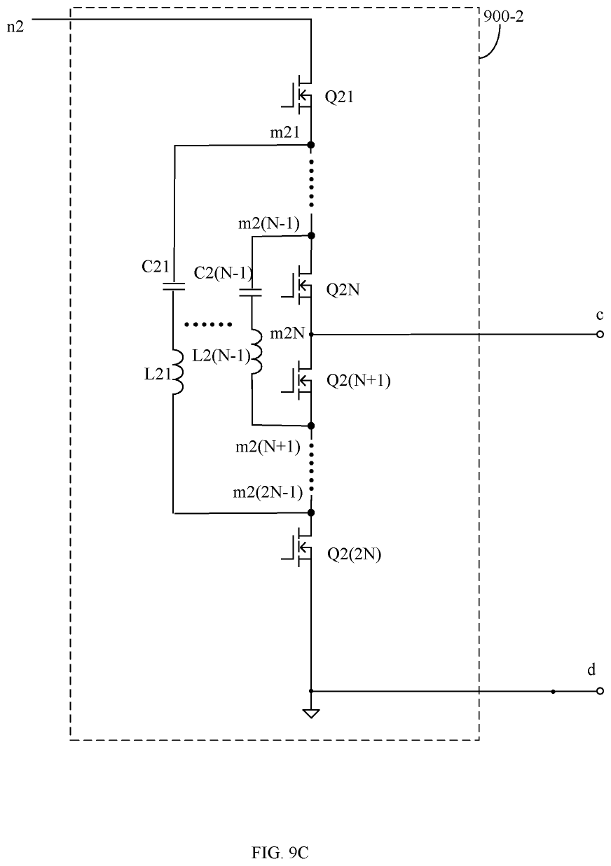

Referring now to FIGS. 9A-9C, shown are schematic diagram of a fourth example power converter, in accordance with embodiments of the present invention. The difference from the third embodiment is that the structures of first switched capacitor 11 and second switched capacitor 21 are different. For example, switched capacitor circuit 1 (900-1) can include 2N fifth power switches Q11 to Q1(2N) connected in series, N−1 first flying capacitors C11 to C1 (N−1), and N−1 first inductors L11˜L1(N−1) respectively corresponding to N−1 first flying capacitors C11˜C1(N−1). The 2N fifth power switches Q11˜Q1(2N) can be sequentially connected in series between first node n1 and the ground potential to form 2N−1 first intermediate nodes m11˜m1 (2N−1), the rth first flying capacitor C1r and the rth first inductor L1r can connect in series between the rth first intermediate node m1r and the (2N−r)th first intermediate node m1(2N−r), where the second terminal of switched capacitor circuit 1 is configured as the Nth first intermediate node m1N, r is less than N, and N is greater than or equal to 2.

Switched capacitor circuit 2 (900-2) can include 2N sixth power switches Q21 to Q2(2N) connected in series, N−1 second flying capacitors C21 to C2(N−1), and N−1 second inductors L21˜L2(N−1) respectively corresponding to the N−1 second flying capacitors. The 2N sixth power switches Q21˜Q2(2N) can connect in series between second node n2 and the ground potential to form 2N−1 second intermediate nodes m21˜m2(2N−1), the rth second flying capacitor C2r and the rth second inductor L2r can connect in series between the rth second intermediate node m2r and the (2N−r)th second intermediate node m2(2N−r), where the second terminal of switched capacitor circuit 2 is configured as the Nth second intermediate node m2N, r is less than N, and N is greater than or equal to 2.

In this example, the power converter can also include a control circuit, and the control circuit can control the switching states of the respective power switches, such that: the switching states of power switches Q1 and Q3 are the same, the switching states of power switches Q2 and Q4 are the same, and the duty ratios of the first to fourth power switches are D, where D=1/N. Further, power switches Q1 and Q2 may be under phase-shifted control, and the phase difference between the turn-on moments of power switch Q1 (or power switch Q3) and power switch Q2 (or power switch Q4) is 360°/N.

Further, the duty ratios of power switches Q1, Q3, the first N fifth power switches (e.g., fifth power switches Q11 to Q1N), second power switch, fourth power switch, and the first N sixth power switches (e.g., sixth power switches Q21 to Q2N) are the same, and are equal to 1/N. The switching states of the 1^{st} sixth power switch Q21 and power switch Q3 can be controlled to be the same, and the 1^{st} sixth power switch Q21 to the Nth sixth power switch Q2N are under phase-shifted control, such that the phase difference between the turn-on moments of every two adjacent power switches in the 1^{st} to the Nth sixth power switches is 360°/N. The switching states of the (2N−n+1)th sixth power switch Q2(2N−n+1) and the nth sixth power switch Q2n are complementary, and n is less than or equal to N.

Similarly, the switching states of the 1^{st} fifth power switch Q11 and power switch Q2 may be controlled to be the same, and the 1^{st} fifth power switch Q11 to the Nth fifth power switch Q1N are under phase-shifted control, such that the phase difference between the turn-on moments of every two adjacent power switches in the 1^{st} to the Nth fifth power switches is 360°/N. The switching states of the (2N−n+1)th fifth power switch Q1(2N−n+1) and the nth fifth power switch Q1n are complementary, and n is less than or equal to N. In this example, one operation cycle can include N operation intervals, and in each operation interval, the resonant frequency of the equivalent capacitor and the equivalent inductor in the first operation loop is controlled to be equal to the resonant frequency of the equivalent capacitor and the equivalent inductor in the second operation loop. The resonant frequency can be controlled to be equal to the working frequency of the power converter, such that the power converter works in a resonant state in each operation interval.

The capacitance values of the first energy storage element, the first flying capacitors and the second flying capacitors, and the inductance values of the first magnetic element, the first inductors, and the second inductors can be controlled to make the resonant frequency of the equivalent capacitor and the equivalent inductor in the first operation loop equal to the resonant frequency of the equivalent capacitor and the equivalent inductor in the second operation loop, and the resonant frequency is controlled to be equal to the working frequency of the power converter, such that the power converter operates in the resonant state.

In one example, when the capacitance values of energy storage element C1, first flying capacitors C11-C1N and second flying capacitors C21 and C2N are equal, and the inductance values of magnetic element L1, first inductors L11-L1N, and second inductors L21˜L2N are equal, that is, C1=C11= . . . =C1N=C21= . . . =C2N, and L1=L11= . . . =L1N=L21˜L2N, the resonant frequency of the equivalent capacitor and the equivalent inductor in the first operation loop is equal to the resonant frequency of the equivalent capacitor and the equivalent inductor in the second operation loop in each operation interval. In addition, the resonant frequency of the power converter remains unchanged in each operation interval and the current waveform is symmetrical.

In this example, by controlling the switching state of each power switch, output voltage Vout is equal to 1/(2*N) of input voltage Vin, that is, Vout=1/(2*N)*Vin, where N is greater than or equal to 2, such that the power converter can efficiently complete the voltage conversion of 1/(2*N):1 with fewer power switches coupled in series, thereby making the implementation of the driving circuit simpler, and reducing the circuit cost. Moreover, in this example, the power converter works in the resonant state, such that the power switches in the power converter operate in the ZCS state, and the switching loss is reduced. In this example, the current peak in the first operation loop and the second operation loop in each operation interval is reduced, such that the current ripple is reduced, the switching loss is reduced, the efficiency of the power converter is improved, and electromagnetic interference (EMI) is reduced.

In other examples, the power converter may not include magnetic element L1, such that magnetic element L1 is not included in the first operation loop and the second operation loop in each operation interval. Other working processes and control methods may be the same as those in this example. The capacitance values of the first energy storage element, the first flying capacitors and the second flying capacitors, and the inductance values of the first inductors and the second inductors are controlled, such that the resonant frequency of the equivalent capacitor and the equivalent inductor in the first operation loop is equal to the resonant frequency of the equivalent capacitor and the equivalent inductor in the second operation loop in each operation interval, and the resonant frequency is controlled to be equal to the working frequency of the power converter, such that the power converter works in the resonant state. When the power converter does not include magnetic element L1, e.g., when the capacitance values of first flying capacitors C11-C1N and second flying capacitors C21-C2N are equal, the capacitance of energy storage element C1 is much larger than the capacitance of first flying capacitor C11, and when the inductance values of first inductors L11˜L1N and second inductors L21˜L2N are equal, that is, C1>>C11= . . . =C1N=C21= . . . =C2N, L11= . . . =L1N=L21= . . . =L2N, the resonant frequency of the equivalent capacitor and the equivalent inductor in the first operation loop is equal to the resonant frequency of the equivalent capacitor and the equivalent inductor in the second operation loop in each operation interval. In addition, the resonant frequency of the power converter in each operation interval remains unchanged and the current waveform is symmetrical.

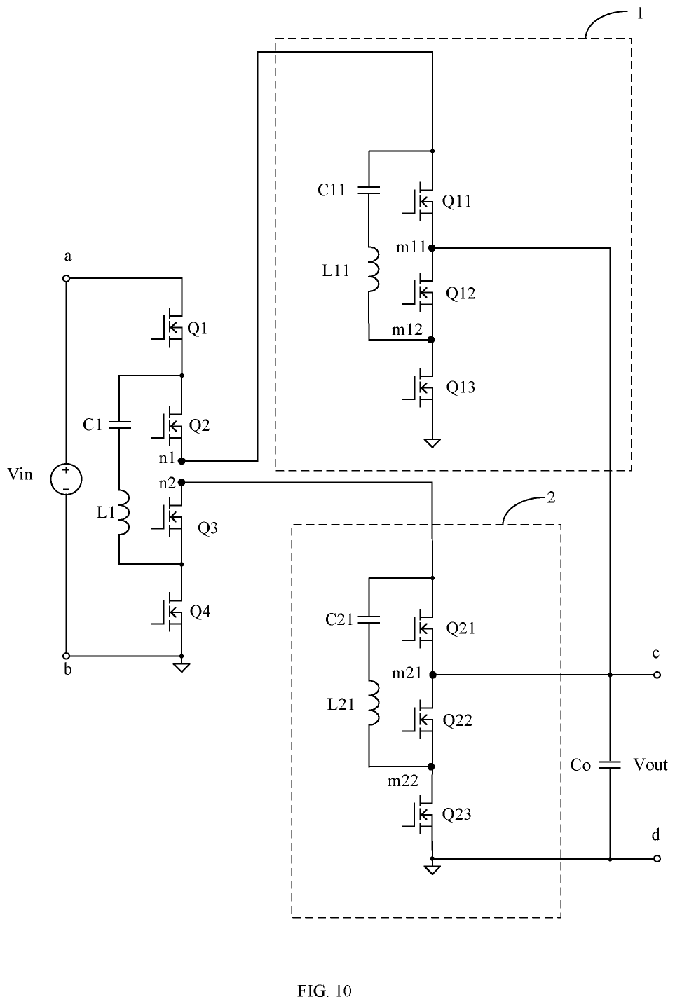

Referring to FIG. 10, shown is a schematic diagram of a fifth example power converter, in accordance with embodiments of the present invention. The difference from the first example is that the power converter can also include magnetic element L1, where energy storage element C1 and magnetic element L1 can connect in series between the common terminal of power switches Q1 and Q2 and the common terminal of power switches Q3 and Q4. Moreover, the structures of switched capacitor circuits 1 and 2 are different. For example, switched capacitor circuit 1 can include three fifth power switches Q11 to Q13 connected in series, one first flying capacitor C11 and one first inductor L11. The fifth power switches Q11 to Q13 may be sequentially connected in series between first node n1 and the ground potential to form two first intermediate nodes m11 and m12, and first flying capacitor C11 and first inductor L11 are connected in series between first nodes n1 and the 2^{nd} first intermediate node m12, where the second terminal of switched capacitor circuit 1 is configured as the 1^{st} first intermediate node m11. Switched capacitor circuit 2 can include three sixth power switches Q21 to Q23 connected in series, one second flying capacitor C21 and one second inductor L21. The sixth power switches Q21 to Q23 can be sequentially connected in series between second node n2 and the ground potential to form two second intermediate nodes m21 and m22, and second flying capacitor C21 and second inductor L21 can connect in series between second node n2 and the 2^{nd} second intermediate node m22, where the second terminal of switched capacitor circuit 2 is configured as the 1^{st} second intermediate node m21.

In this example, the power converter can also include a control circuit, and the control circuit can control the switching states of the respective power switches, so that: the switching states of power switches Q1 and Q3 are the same, the switching states of power switches Q2 and Q4 are the same, and the duty ratios of the first to fourth power switches are D, where D=½. Further, power switches Q1 and Q2 can be under phase-shifted control, and the phase difference between the turn-on moments of power switch Q1 (or power switch Q3) and power switch Q2 (or power switch Q4) is 180°. The phase difference between the turn-on moments of the 1^{st} sixth power switch Q21 and power switch Q3 is 180°, the switching states of the 2^{nd} sixth power switch Q22 and the 1^{st} sixth power switch Q21 are complementary, and the switching states of the 3^{rd} sixth power switch Q23 and power switch Q3 are complementary. The phase difference between the turn-on moments of the 1^{st} fifth power switch Q11 and power switch Q2 is 180°, the switching states of the 2^{nd} fifth power switch Q12 and the 1^{st} fifth power switch Q11 are complementary, and the 3^{rd} fifth power switch Q13 and power switch Q2 are complementary.

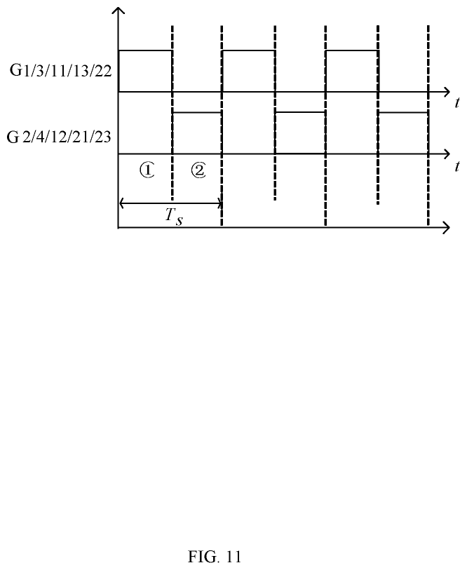

Referring now to FIG. 11, shown is a waveform diagram of example control signals for the fifth example power converter, in accordance with embodiments of the present invention. In this example, G1/3/11/13/22 is the control signal for power switches Q1, Q3, Q11, Q13, and Q22, G2/4/12/21/23 is the control signal for power switches Q2, Q4, Q12, Q21, and Q23.

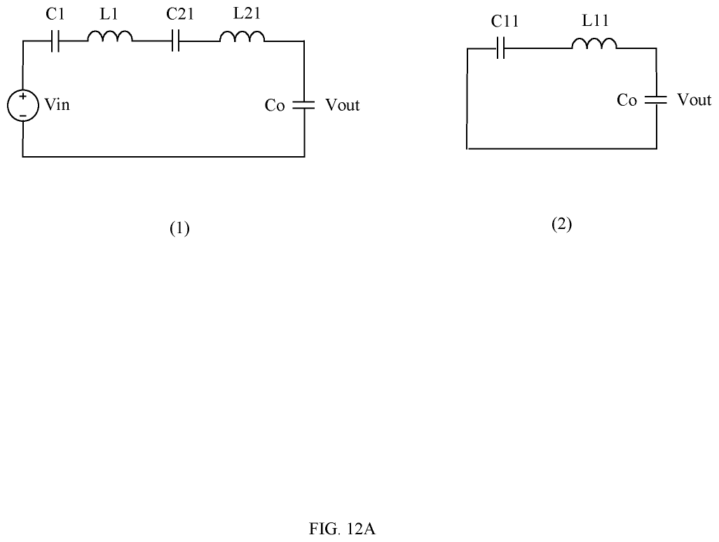

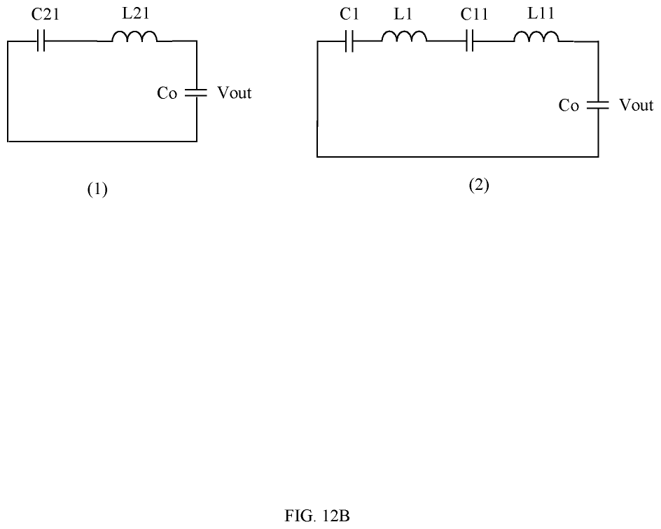

Referring now to FIGS. 12A-12B, shown are schematic diagrams of equivalent circuits of the fifth example power converter in each operation interval, in accordance with embodiments of the present invention. The working process of the fifth example power converter will be explained with reference to FIGS. 11 and 12A-12B. As shown in FIG. 11, in the operation interval \textcircled{1}, control signal G1/3/11/13/22 is at a high level, and thus power switch Q1, power switch Q3, fifth power switch Q11, fifth power switch Q13 and sixth power switch Q22 are turned on. At this time, the first operation loop is: Vin-Q1-C1-L1-Q3-C21-L21-Q22-load-Vin, and the equivalent circuit diagram is shown in (1) of FIG. 12A; that is, input voltage Vin supplies power to the load through energy storage element C1, magnetic element L1, second flying capacitor C21 and second inductor L21. The second operation loop is: C11-Q11-load-Q13-L11-C11, and the equivalent circuit diagram is shown in (2) of FIG. 12A; that is, first flying capacitor C11 supplies power to the load through first inductor L11. Further, in the operation interval \textcircled{1}, the resonant frequency of the equivalent capacitor and the equivalent inductor in the first operation loop is controlled to be equal to the resonant frequency of the capacitor and the inductor in the second operation loop, and the resonant frequency is controlled to be equal to the working frequency of the power converter, such that the power converter works in the resonant state in the operation interval \textcircled{1}. In an embodiment, when the capacitance values of energy storage element C1, first flying capacitor C11 and second flying capacitor C21 are equal, and the inductance values of magnetic element L1, first inductor L11, and second inductor L21 are equal; that is, when C1=C11=C21, and L1=L11=L21, the resonant frequency of the equivalent capacitor and the equivalent inductor in the first operation loop is equal to the resonant frequency of the capacitor and the inductor in the second operation loop in the operation interval \textcircled{1}.

In the operation interval \textcircled{2}, control signal G2/4/12/21/23 is at a high level, and thus power switch Q2, power switch Q4, fifth power switch Q12, sixth power switch Q21, and sixth power switch Q23 are turned on. At this time, the first operation loop is: C21-Q21-load-Q23-L21-C21, and the equivalent circuit diagram is shown in (1) of FIG. 12B; that is, second flying capacitor C21 supplies power to the load through second inductor L21. The second operation loop is: C1-Q2-C11-L11-Q12-load-Q4-L1-C1, and the equivalent circuit diagram is shown in FIG. 12b (2), that is, energy storage element C1 supplies power to the load through first flying capacitor C11, first inductor L11, and magnetic element L1. Further, in the operation interval \textcircled{2}, the resonant frequency of the capacitor and the inductor in the first operation loop is controlled to be equal to the resonant frequency of the equivalent capacitor and the equivalent inductor in the second operation loop, and the resonant frequency is controlled to be equal to the working frequency of the power converter, such that the power converter works in the resonant state in the operation interval \textcircled{2}. In one example, when the capacitance values of energy storage element C1, first flying capacitor C11 and second flying capacitor C21 are equal, and the inductance values of magnetic element L1, first inductor L11, and second inductor L21 are equal, that is, when C1=C11=C21, and L1=L11=L21, the resonant frequency of the capacitor and the inductor in the first operation loop is equal to the resonant frequency of the equivalent capacitor and the equivalent inductor in the second operation loop in the operation interval \textcircled{2}. Moreover, when the capacitance values of energy storage element C1, first flying capacitor C11 and second flying capacitor C21 are equal, and the inductance values of magnetic element L1, first inductor L11 and second inductor L21 are equal; that is, when C1=C11=C21, and L1=L11=L21, the resonant frequency of the power converter in the operation interval \textcircled{1} and the operation interval \textcircled{2} remains unchanged, and the current waveform is symmetrical.

The operation intervals \textcircled{1}˜\textcircled{2} form one operation cycle Ts. In this example, by controlling the switching states of each power switch, output voltage Vout is equal to ¼ of input voltage Vin, that is, Vout=¼*Vin, such that the power converter can efficiently complete the voltage conversion of 4:1. In this example, only three power switches are coupled in series in the power converter, which reduces the number of power switches coupled in series, such that the realization of the driving circuit can be made simpler and the circuit cost can be reduced. Moreover, in this example, the power converter works in the resonant state, so the power switch in the power converter works in the ZCS state, and the switching loss is reduced. Compared with the first example, the current peak in the first operation loop and the second operation loop in each operation interval of this example are reduced, the current ripple is reduced, the switching loss is reduced, and the efficiency of the power converter is improved, and the EMI interference is reduced.

In other examples, the power converter may not include magnetic element L1, so that magnetic element L1 is not included in the first operation loop in the operation interval \textcircled{1} and the second operation loop in the operation interval \textcircled{2}. Other working processes and control methods can be the same as those in this example. When the power converter does not include magnetic element L1, e.g., when capacitance values of first flying capacitor C11 and second flying capacitor C21 are equal, the capacitance of energy storage element C1 is much larger than that of first flying capacitor C11, and the inductance values of first inductor L11 and second inductor L21 are equal, that is, when C1>>C11=C21, and L11=L21, the resonant frequency of the equivalent capacitor and equivalent inductor in the first operation loop is controlled to be equal to the resonant frequency of the equivalent capacitor and equivalent inductor in the second operation loop in the operation interval \textcircled{1} and operation interval \textcircled{2}, respectively. In addition, the resonant frequency of the power converter in the operation interval \textcircled{1} and operation interval \textcircled{2} remains unchanged, and the current waveform is symmetrical.

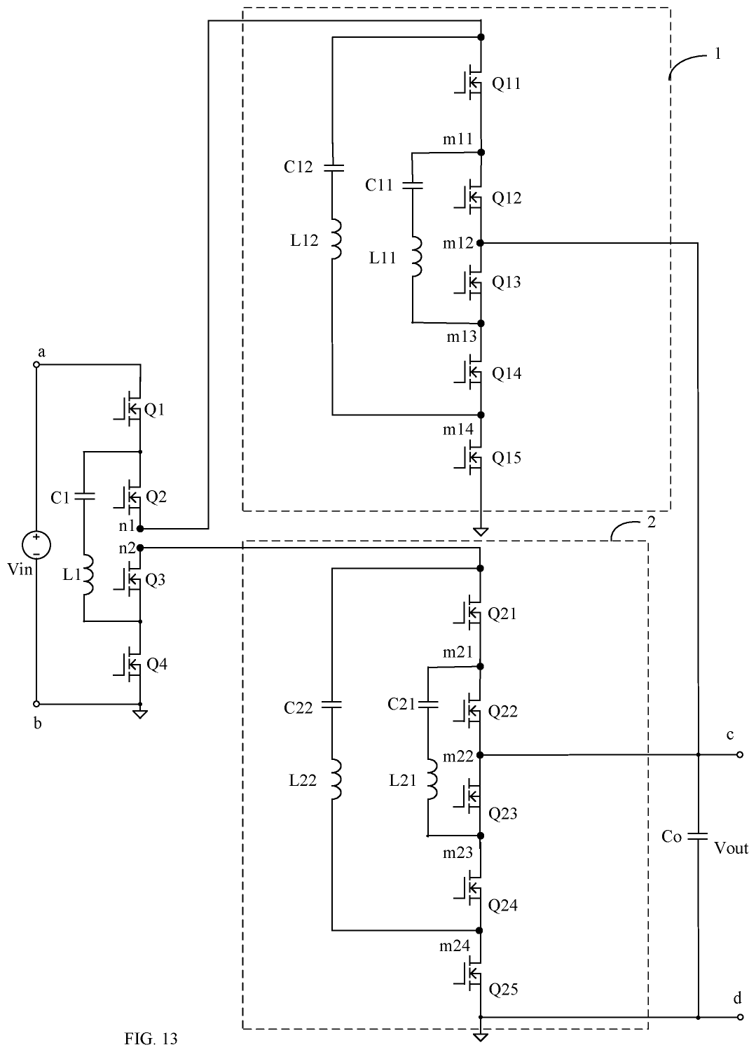

Referring now to FIG. 13, shown is a schematic diagram of a sixth example power converter, in accordance with embodiments of the present invention. The difference from the fifth embodiment is that the structures of switched capacitor circuits 1 and 2 are different. For example, switched capacitor circuit 1 can include five fifth power switches Q11 to Q15 connected in series, two first flying capacitors C11 and C12, and two first inductors L11, and L12. The fifth power switches Q11˜Q15 may be sequentially connected in series between first node n1 and the ground potential to form four first intermediate nodes m11˜m14. The 1^{st} first flying capacitor C11 and the 1^{st} first inductor L11 can connect in series between the 1^{st} first intermediate node m11 and the 3^{rd} first intermediate node m13, and the 2^{nd} first flying capacitor C12 and the 2^{nd} first inductor L12 are connected in series between first node n1 and the 4^{th} first intermediate node m14, where the second terminal of switched capacitor circuit 1 is configured as the 2^{nd} first intermediate node m12. Switched capacitor circuit 2 can include five sixth power switches Q21 to Q25 connected in series, two second flying capacitors C21 and C22, and two second inductors L21 and L22. The sixth power switches Q21 to Q25 are sequentially connected in series between second node n2 and the ground potential to form four second intermediate nodes m21˜m24. The 1^{st} second flying capacitor C21 and the 1^{st} second inductor L21 are connected in series between the 1^{st} second intermediate node m21 and the 3^{rd} second intermediate node m23, the 2^{nd} second flying capacitor C22 and the 2^{nd} second inductor L22 are connected in series between second node n2 and the 4^{th} second intermediate node m24, where the second terminal of Switched capacitor circuit 21 is configured as the 2^{nd} second intermediate node m22.

In this example, the power converter can also include a control circuit, and the control circuit is used to control the switching states of the respective power switches, so that: the switching states of power switches Q1 and Q3 are the same, the switching states of power switches Q2 and Q4 are the same, and the duty ratios of first to fourth power switches are D, where D=⅓. In addition, power switches Q1 and Q2 may be under phase-shifted control, and the phase difference between the turn-on moments of power switch Q1 (or power switch Q3) and power switch Q2 (or power switch Q4) is 120°. Further, the phase difference between the turn-on moments of the 1^{st} sixth power switch Q21 and power switch Q3 is 120°, and the phase difference between the turn-on moments of the 2^{nd} sixth power switch Q22 and the 1^{st} sixth power switch Q21 is 120°, the switching states of the 3^{rd} sixth power switch Q23 and the 2^{nd} sixth power switch Q22 are complementary, the switching states of the 4^{th} sixth power switch Q24 and the 1^{st} sixth power switch Q21 are complementary, the switching states of the 5^{th} sixth power switch Q25 and power switch Q3 are complementary. The phase difference between the turn-on moments of the 1^{st} fifth power switch Q11 and power switch Q2 is 120°, and the phase difference between the turn-on moments of the 2^{nd} fifth power switch Q12 and the 1^{st} fifth power switch Q11 is 120°, the switching states of the 3^{rd} fifth power switch Q13 and the 2^{nd} fifth power switch Q12 are complementary, the switching states of the 4^{th} fifth power switch Q14 and the 1^{st} fifth power switch Q11 are complementary, and the switching states of the 5^{th} fifth power switch Q15 and power switch Q2 are complementary.

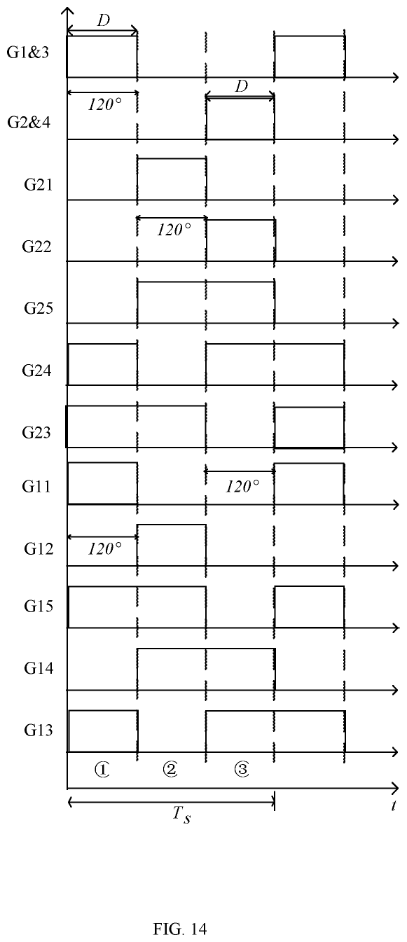

Referring now to FIG. 14, shown is a waveform diagram of example control signals for the sixth example power converter, in accordance with embodiments of the present invention. In this example, G1&3 is the control signal for power switches Q1 and Q3, G2&4 is the control signal for power switches Q2 and Q4, G21˜G25 are the control signals for sixth power switches Q21˜Q25 respectively, and G11˜G15 are the control signals for fifth power switches Q11˜G15, respectively.

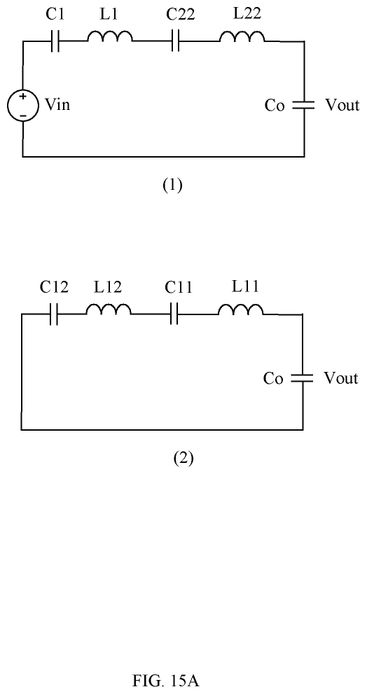

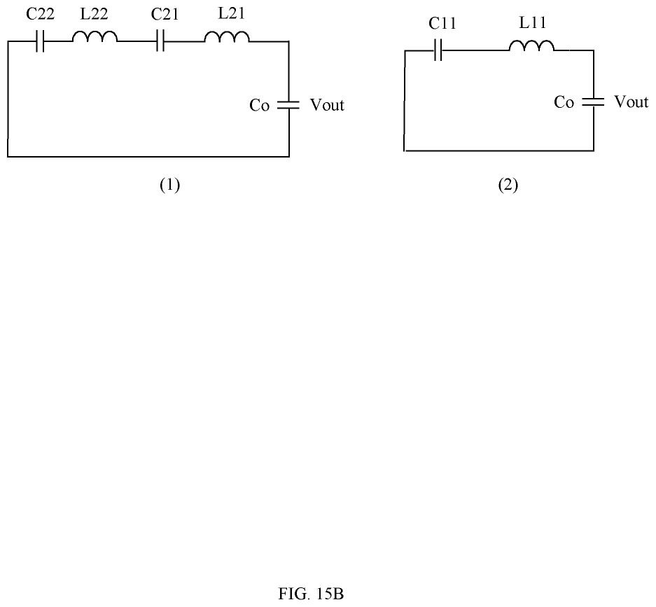

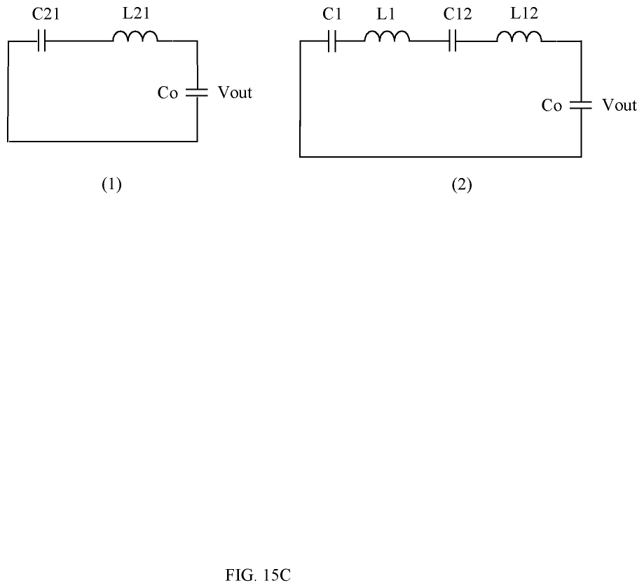

Referring now to FIGS. 15A-15C, shown are schematic diagrams of equivalent circuits of the sixth example power converter in each operation interval, in accordance with embodiments of the present invention. The working process of the sixth example power converter will be explained with reference to FIGS. 14 and 15A-15C. As shown in FIG. 14, in the operation interval \textcircled{1}, control signals G1&3, G24 and G23 are at high level, thus power switch Q1, power switch Q3, and sixth power switches Q23 and Q24 are turned on. At this time, the first operation loop is: Vin-Q1-C1-L1-Q3-C22-L22-Q24-Q23-load-Vin, and the equivalent circuit diagram is shown in (1) of FIG. 15A; that is, input voltage Vin supplies power to the load through energy storage element C1, magnetic element L1, second flying capacitor C22 and second inductor L22. Moreover, in the operation interval \textcircled{1}, control signals G11, G15 and G13 are at high level, and thus fifth power switches Q11, Q13 and Q15 are turned on. Thus, the second operation loop is: C12-Q11-C11-L11-Q13-load-Q15-L12-C12, and the equivalent circuit diagram is shown in (2) of FIG. 15A; that is, second flying capacitor C12 supplies power to the load through first flying capacitor C11, first inductor L11, and first inductor L12. Also, in the operation interval \textcircled{1}, the resonant frequency of the equivalent capacitor and the equivalent inductor in the first operation loop is controlled to be equal to the resonant frequency of the equivalent capacitor and the equivalent inductor in the second operation loop, and the resonant frequency is controlled to be equal to the working frequency of the power converter, so that the power converter works in the resonant state in the operation interval \textcircled{1}. In one example, when the capacitance values of energy storage element C1, first flying capacitors C11 and C12, and second flying capacitors C21 and C22 are equal, and the inductance values of magnetic element L1, first inductors L11 and L12 and second inductors L21 and L22 are equal; that is, C1=C11=C12=C21=C22, and L1=L11=L12=L21=L22, the resonant frequency of the equivalent capacitor and the equivalent inductor in the first operation loop is equal to the resonant frequency of the equivalent capacitor and the equivalent inductor in the second operation loop in the operation interval \textcircled{1}.

In the operation interval \textcircled{2}, control signals G21, G23, and G25 are at high level, and thus sixth power switches Q21, Q23, and Q25 are turned on. At this time, the first operation loop is: C22-Q21-C21-L21-Q23-load-Q25-L22-C22, and the equivalent circuit diagram is shown in (1) of FIG. 15B; that is, second flying capacitor C22 supplies power to the load through second flying capacitor C21, second inductor L21 and second inductor L22. At the same time, in the operation interval \textcircled{2}, control signals G12, G14, and G15 are at high level, and thus fifth power switches Q12, Q14, and Q15 are turned on. At this time, the second operation loop is: C11-Q12-load-Q15-Q14-L11-C11, and the equivalent circuit diagram is shown in (2) of FIG. 15B; that is, first flying capacitor C11 supplies power to the load through first inductor L11. Also, in the operation interval \textcircled{2}, the resonant frequency of the equivalent capacitor and the equivalent inductor in the first operation loop is controlled to be equal to the resonant frequency of the capacitor and the inductor in the second working loop, and the resonant frequency is controlled to be equal to the working frequency of the power converter, so that the power converter works in the resonant state in the operation interval \textcircled{2}. In one example, when the capacitance values of energy storage element C1, first flying capacitors C11 and C12, and second flying capacitors C21 and C22 are equal, and the inductance values of magnetic element L1, first inductors L11 and L12 and second inductors L21 and L22 are equal, that is, C1=C11=C12=C21=C22, and L1=L11=L12=L21=L22, the resonant frequency of the equivalent capacitor and the equivalent inductor in the first operation loop is controlled to be equal to the resonant frequency of the capacitor and the inductor in the second working loop in the operation interval \textcircled{2}.

In the operation interval \textcircled{3}, control signals G22, G24, and G25 are at high level, and thus sixth power switches Q22, Q24, and Q25 are turned on. At this time, the first operation loop is: C21-Q22-load-Q25-Q24-L21-C21, and the equivalent circuit diagram is shown in (1) of FIG. 15C; that is, second flying capacitor C21 supplies power to the load through second inductor L21. At the same time, in the operation interval \textcircled{3}, control signals G2&4, G13 and G14 are at high level, and thus power switch Q2, power switch Q4, and fifth power switches Q13 and Q14 are turned on. At this time, the second operation loop is: C1-Q2-C12-L12-Q14-Q13-load-Q4-L1-C1, and the equivalent circuit diagram is shown in (2) of FIG. 15C; that is, energy storage element C1 supplies power to the load through first flying capacitor C12, first inductor L12 and magnetic element L1. Also, in the operation interval \textcircled{3}, the resonant frequency of the capacitor and the inductor in the first operation loop is controlled to be equal to the resonant frequency of the equivalent capacitor and the equivalent inductor in the second operation loop, and the resonant frequency is controlled to be equal to the working frequency of the power converter, so that the power converter works in the resonant state in the operation interval \textcircled{3}. In one example, when the capacitance values of energy storage element C1, first flying capacitors C11 and C12, and second flying capacitors C21 and C22 are equal, and the inductance values of magnetic element L1, first inductors L11 and L12 and second inductors L21 and L22 are equal, that is, C1=C11=C12=C21=C22, and L1=L11=L12=L21=L22, the resonant frequency of the capacitor and inductor in the first operation loop is equal to the resonant frequency of the equivalent capacitor and equivalent inductor in the second operation loop in the operation interval \textcircled{3}. Moreover, when the capacitance values of energy storage element C1, first flying capacitors C11 and C12, and second flying capacitors C21 and C22 are equal, and the inductance values of magnetic element L1, first inductors L11 and L12 and second inductors L21 and L22 are equal, that is, C1=C11=C12=C21=C22, and L1=L11=L12=L21=L22, the resonant frequency of the power converter in the operation intervals \textcircled{1}˜\textcircled{3} remains unchanged, and the current waveform is symmetrical.

The operation intervals \textcircled{1} to \textcircled{3} may form one operation cycle Ts. In this example, the switching state of each power switch is controlled such that output voltage Vout is equal to ⅙ of input voltage Vin, that is, Vout=⅙ *Vin. Therefore, the power converter can efficiently complete the voltage conversion of 6:1, the number of power switches coupled in series is reduced, thereby making the implementation of the driving circuit simpler and reducing the circuit cost. Moreover, in this example, the power converter works in the resonant state, so the power switches in the power converter work in the ZCS state, and the switching loss is reduced. In this example, the current peak in the first operation loop and the second operation loop in each operation interval is reduced, thereby reducing the current ripple, and thus the switching loss is reduced, the efficiency of the power converter is improved, and the EMI interference is reduced.

In other examples, the power converter may not include magnetic element L1, such that magnetic element L1 is not included in the first operation loop and the second operation loop in each operation interval, and other working processes and control methods are the same as those in this example. When the power converter does not include magnetic element L1, e.g., the capacitance values of first flying capacitors C11 and C12 and second flying capacitors C21 and C22 are equal, and the capacitance of energy storage element C1 is much larger than the capacitance values of first flying capacitor C11, and the inductance values of first inductors L11 and L12 and second inductors L21 and L22 are equal, that is, C1» C11=C12=C21=C22, L11=L12=L21=L22, the resonant frequency of the equivalent capacitor and the equivalent inductor in the first operation loop is equal to the resonant frequency of the equivalent capacitor and the equivalent inductor in the second operation loop in each operation interval. In addition, the resonant frequency of the power converter remains unchanged in the operation intervals \textcircled{1} ˜\textcircled{3}, and the current waveform is symmetrical.

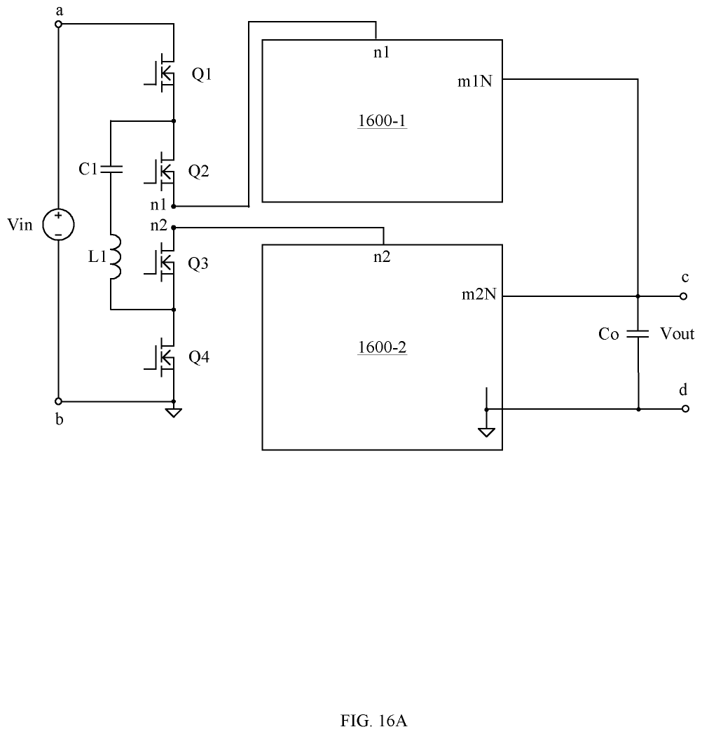

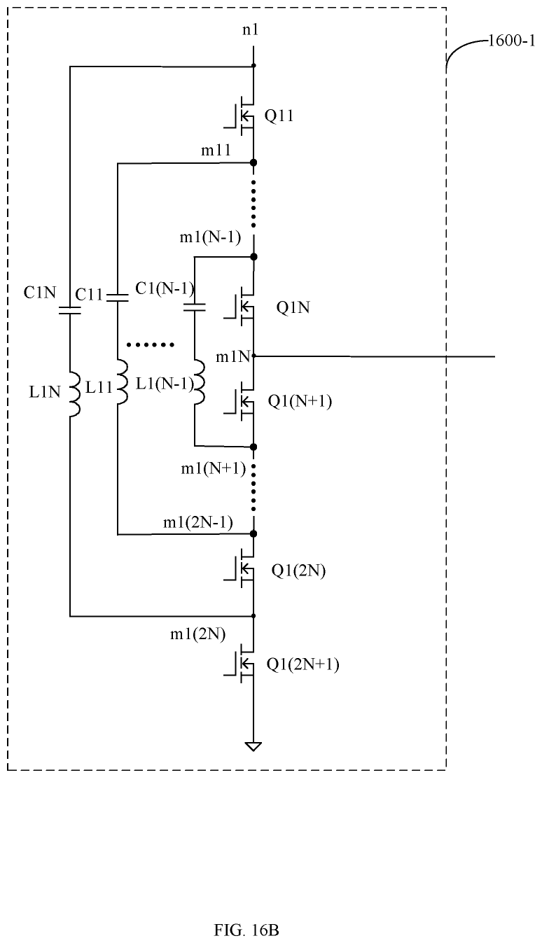

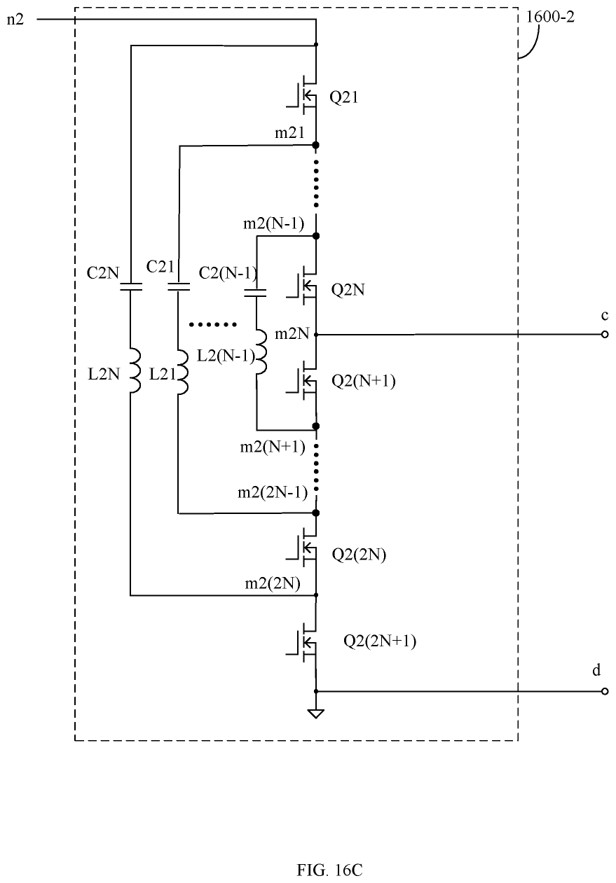

Referring now to FIGS. 16A-16C, shown area schematic diagrams of a seventh example power converter, in accordance with embodiments of the present invention. The difference from the fifth embodiment is that the structures of switched capacitor circuits 1 and 21 are different. For example, switched capacitor circuit 1 (1600-1) can include 2N+1 fifth power switches Q11 to Q1(2N+1) connected in series, N first flying capacitors C11 to C1N, and N first inductors L11-L1N corresponding to the N first flying capacitors C11-C1N one-to-one. The 2N+1 fifth power switches Q11-Q1(2N+1) may be sequentially connected in series between first node n1 and the ground potential to form 2N first intermediate nodes m11˜m1(2N), the Nth first flying capacitor C1N and the Nth first inductor L1N can connect in series between first node n1 and the 2Nth first intermediate node m1 (2N), the rth first flying capacitor C1r and the rth first inductor L1r can connect in series between the rth first intermediate node m1r and the (2N−r)th first intermediate node m1(2N−r), where the second terminal of switched capacitor circuit 1 is configured as the Nth first intermediate node m1N, r is less than N, and N is greater than or equal to 1.

Switched capacitor circuit 2 (1600-2) can include 2N+1 sixth power switches Q21˜Q2(2N+1) connected in series, N second flying capacitors C21˜C2N, and N second inductors L21˜L2N corresponding to N second flying capacitors C21˜C2N one-to-one. The 2N+1 sixth power switches Q21˜Q2 (2N+1) may be sequentially connected in series between second node n2 and the ground potential to form 2N second intermediate nodes m21˜m2(2N), the Nth second flying capacitor C2N and the Nth second inductor L2N can connect in series between second node n2 and the 2Nth second intermediate node m2(2N), the rth second flying capacitor C2r and the rth second inductor L2r can connect in series between the rth second intermediate node m2r and the (2N−r)th second intermediate node m2(2N−r), where the second terminal of switched capacitor circuit 2 is configured as the Nth second intermediate node m2N, where r is less than N, and N is greater than or equal to 1.

In this example, the power converter can also include a control circuit, and the control circuit is used to control the switching states of the respective power switches, so that: the switching states of power switches Q1 and Q3 are the same, the switching states of power switches Q2 and Q4 are the same, and the duty ratios of first to fourth power switches are D, where D=1/(N+1). Further, power switches Q1 and Q2 may be under phase-shifted control, and the phase difference between the turn-on moments of power switch Q1 (or power switch Q3) and power switch Q2 (or power switch Q4) is 360°/(N+1).

Moreover, the duty ratios of power switch Q1, power switch Q3, the first N fifth power switches (e.g., fifth power switches Q11 to Q1N), power switch Q2, power switch Q4, and the first N sixth power switches (e.g., sixth power switches Q21 to Q2N) are the same, and are equal to 1/(N+1). In addition, power switch Q3 and the 1^{st} sixth power switch Q21 to the Nth sixth power switch Q2N are under phase-shifted control, such that the phase difference between the turn-on moments of every two adjacent power switches in power switch Q3 and the 1^{st} sixth power switch Q21 to the Nth sixth power switch Q2N is 360°/(N+1). The switching states of the (2N+1)th sixth power switch Q2(2N+1) and power switch Q3 can be complementary, and the switching states of the (2N−n+1)th sixth power switch Q2(2N−n+1) and the nth sixth power switch Q2n may be complementary, where n is less than or equal to N. Similarly, power switch Q2 and the 1^{st} fifth power switch Q11 to the Nth fifth power switch Q1N are under phase-shifted control, such that the phase difference between the turn-on moments of every two adjacent power switches in power switch Q2 and the 1^{st} fifth power switch Q11 to the Nth fifth power switch Q1N is 360°/(N+1). The switching states of the (2N+1)th fifth power switch Q1(2N+1) and power switch Q2 can be complementary, and the switching states of the (2N−n+1)th fifth power switch Q1(2N−n+) and the nth fifth power switch Q1n may be complementary, where n is less than or equal to N.

In this example, one operation cycle can include N+1 operation intervals, and in each operation interval, the resonant frequency of the equivalent capacitor and the equivalent inductor in the first operation loop can be controlled to be equal to that of the equivalent capacitor and the equivalent inductor in the second operation loop, and the resonant frequency is controlled to be equal to the working frequency of the power converter, such that the power converter operates in the resonant state in each operation interval.

The capacitance values of the first energy storage element, the first flying capacitors and the second flying capacitors, and the inductance values of the first magnetic element, the first inductors and the second inductors may be controlled to make the resonant frequency of the equivalent capacitor and the equivalent inductor in the first operation loop equal to the resonant frequency of the equivalent capacitor and the equivalent inductor in the second operation loop, and the resonant frequency can be controlled to be equal to the working frequency of the power converter, such that the power converter operates in the resonant state.

In one example, when the capacitance values of energy storage element C1, first flying capacitors C11-C1N and second flying capacitors C21 and C2N are equal, and the inductance values of magnetic element L1, first inductors L11˜L1N and second inductors L21˜L2N are equal; that is, C1=C11= . . . =C1N=C21= . . . =C2N, and L1=L11= . . . =L1N=L21˜L2N, the resonant frequency of the equivalent capacitor and the equivalent inductor in the first operation loop is equal to the resonant frequency of the equivalent capacitor and the equivalent inductor in the second operation loop in each operation interval. In addition, the resonant frequency of the power converter remains unchanged in each operation interval and the current waveform is symmetrical.

In this example, by controlling the switching state of each power switch, output voltage Vout is equal to 1/(2*(N+1)) of input voltage Vin, that is, Vout=1/(2*(N+1))*Vin, where N is greater than or equal to 1. Thus, the power converter can efficiently complete the voltage conversion of 1/(2*(N+1)): 1 with fewer power switches coupled in series, such that the realization of the driving circuit can be made simpler and the circuit cost can be reduced. Moreover, in this embodiment, the power converter works in the resonant state, so the power switch in the power converter works in the ZCS state, and the switching loss is reduced. In this example, the current peak in the first operation loop and the second operation loop in each operation interval is reduced, such that the current ripple is reduced, the switching loss is reduced, the efficiency of the power converter is improved, and the EMI interference is reduced.

In other examples, the power converter may not include magnetic element L1, such that magnetic element L1 is not included in the first operation loop and the second operation loop in each operation interval. Other working processes and control methods can be the same as those in this example. The capacitance values of the first energy storage element, the first flying capacitors and the second flying capacitors, and the inductance values of the first inductors and the second inductors are controlled, such that the resonant frequency of the equivalent capacitor and the equivalent inductor in the first operation loop is equal to the resonant frequency of the equivalent capacitor and the equivalent inductor in the second operation loop in each operation interval, and the resonant frequency is controlled to be equal to the working frequency of the power converter, such that the power converter works in the resonant state. When the power converter does not include magnetic element L1, e.g., when the capacitance values of first flying capacitors C11-C1N and second flying capacitors C21-C2N are equal, the capacitance of energy storage element C1 is much larger than the capacitance of first flying capacitor C11, and when the inductance values of first inductors L11˜L1N and second inductors L21˜L2N are equal, that is, C1>>C11= . . . =C1N=C21= . . . =C2N, L11= . . . =L1N=L21= . . . =L2N, the resonant frequency of the equivalent capacitor and the equivalent inductor in the first operation loop is equal to the resonant frequency of the equivalent capacitor and the equivalent inductor in the second operation loop in each operation interval. In addition, the resonant frequency of the power converter in each operation interval remains unchanged and the current waveform is symmetrical.

For example, the power switches Q1 and Q2 being under phase-shifted control as described herein can include the following two cases: (i) the turn-on moment of power switch Q1 is ahead of that of power switch Q2; and (ii) the turn-on moment of power switch Q2 is ahead of that of power switch Q1. Also, phase difference between the turn-on moments of power switches Q1 and Q2 is φ° as described herein can include the following two cases: (i) the turn-on moment of power switch Q1 is ahead of that of power switch Q2 by φ°; and (ii) the turn-on moment of power switch Q2 is ahead of that of power switch Q1 by φ°. In particular embodiments, the phase-shifted control and the phase difference between the turn-on moments is φ° of any two power switches can all include the above-mentioned cases.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A power converter, comprising:
a) a positive input terminal and a negative input terminal, configured to receive an input voltage;
b) a positive output terminal and a negative output terminal, configured to generate an output voltage;
c) a first power switch and a second power switch, sequentially coupled in series between the positive input terminal and a first node;
d) a third power switch and a fourth power switch, sequentially coupled in series between a second node and the negative input terminal;
e) a first energy storage element coupled between a common terminal of the first power switch and the second power switch and a common terminal of the third power switch and the fourth power switch;
f) a first switched capacitor circuit coupled between the first node and the positive output terminal; and
g) a second switched capacitor circuit coupled between the second node and the positive output terminal.

2. The power converter of claim 1, wherein there is no direct physical connection between the first node and the second node.

3. The power converter of claim 2, wherein the first switched capacitor circuit comprises:
a) 2N+1 fifth power switches connected in series and N first flying capacitors, wherein the 2N+1 fifth power switches are sequentially connected in series between the first node and a ground potential to form 2N first intermediate nodes, a Nth first flying capacitor is coupled between the first node and a 2Nth first intermediate node and an rth first flying capacitor is coupled between an rth first intermediate node and a (2N−r)th first intermediate node, wherein a Nth first intermediate node is coupled to the positive output terminal, and r is less than N, N is an integer greater than or equal to 1; and
b) the second switched capacitor circuit comprises 2N+1 sixth power switches connected in series and N second flying capacitors, wherein the 2N+1 sixth power switches are sequentially connected in series between the second node and the ground potential to form 2N second intermediate nodes, and a Nth second flying capacitor is coupled between the second node and a 2Nth second intermediate node, an rth second flying capacitor is coupled between an rth second intermediate node and a (2N−r)th second intermediate node, wherein a second terminal of the second switched capacitor circuit is configured as a Nth second intermediate node.

4. The power converter of claim 3, wherein the first switched capacitor circuit further comprises:
a) N first inductors corresponding to the N first flying capacitors one-to-one, wherein each of the N first inductors is coupled to a corresponding one of the first flying capacitors; and
b) N second inductors corresponding to the N second flying capacitors one-to-one, wherein each of the N second inductors is coupled to a corresponding one of second flying capacitors.

5. The power converter of claim 4, wherein the power converter further comprises a first magnetic element, coupled in series with the first energy storage element.

6. The power converter of claim 3, wherein switching states of the first to the fourth power switches and each of the fifth and the sixth power switches are controlled, such that the output voltage is equal to 1/(2*(N+1)) of the input voltage.

7. The power converter of claim 6, wherein duty ratios of the first to the fourth power switches, the first N fifth power switches and the first N sixth power switches are respectively equal to 1/(N+1), switching states of the first power switch and the third power switch are the same, and switching states of the second power switch and the fourth power switch are the same, wherein the first power switch and the second power switch are under phase-shifted control, and a phase difference between turn-on moments of the first and second power switches is 360°/(N+1).

8. The power converter of claim 6, wherein switching states of a (2N+1)th fifth power switch and the second power switch are complementary, switching states of a (2N−n+1)th fifth power switch and a nth fifth power switch are complementary, switching states of a (2N+1)th sixth power switch and the third power switch are complementary, and switching states of a (2N−n+1)th sixth power switch and a nth sixth power switch are complementary, wherein n is less than or equal to N.

9. The power converter of claim 6, wherein:
a) the second power switch and 1^{st} to Nth fifth power switches are under phase-shifted control, such that a phase difference between turn-on moments of every two adjacent power switches in the second power switch and the 1^{st} to the Nth fifth power switches is 360°/(N+1); and
b) the third power switch and 1^{st} to Nth sixth power switches are under phase-shifted control, such that a phase difference between turn-on moments of every two adjacent power switches in the third power switch and the 1^{st} to the Nth sixth power switches is 360°/(N+1).

10. The power converter of claim 4, wherein capacitance values of the first flying capacitors and the second flying capacitors are equal, a capacitance value of the first energy storage element is greater than that of the first flying capacitor, and inductance values of the first inductors and the second inductors are equal, such that resonant frequencies of the power converter in each operation loop of each operation interval in one operation cycle are the same, and thus the power converter operates in a resonant state.

11. The power converter of claim 5, wherein capacitance values of the first energy storage element, the first flying capacitors and the second flying capacitors are equal and inductance values of the first magnetic element, the first inductors and the second inductors are equal, such that resonant frequencies of the power converter in each operation loop of each operation interval in one operation cycle are the same, and thus the power converter operates in a resonant state.

12. The power converter of claim 1, wherein the first node and the second node are connected together.

13. The power converter of claim 12, wherein the first switched capacitor circuit comprises:
a) 2N fifth power switches connected in series, N−1 first flying capacitors, and N−1 first inductors, wherein the 2N fifth power switches are sequentially connected in series between the first node and a ground potential to form 2N−1 first intermediate nodes, an rth first flying capacitor and an rth first inductor are connected in series between an rth first intermediate node and a (2N−r)th first intermediate node, wherein a Nth first intermediate node is coupled to the positive output terminal, r is less than N, and N is an integer greater than 1; and
b) the second switched capacitor circuit comprises 2N sixth power switches connected in series, N−1 second flying capacitors, and N−1 second inductors, wherein the 2N sixth power switches are sequentially connected in series between the second node and the ground potential to form 2N−1 second intermediate nodes, an rth second flying capacitor and an rth second inductor are connected in series between an rth second intermediate node and a (2N−r)th second intermediate node, wherein a Nth second intermediate node is coupled to the positive output terminal.

14. The power converter of claim 13, wherein the power converter comprises a first magnetic element, coupled in series with the first energy storage element.

15. The power converter of claim 12, wherein capacitance values of the first flying capacitors and the second flying capacitors are equal, a capacitance value of the first energy storage element is greater than that of the first flying capacitor, and inductance values of the first inductors and the second inductors are equal, such that resonant frequencies of the power converter in each operation loop of each operation interval in one operation cycle are the same, and thus the power converter operates in a resonant state.

16. The power converter of claim 13, wherein capacitance values of the first energy storage element, the first flying capacitors and the second flying capacitors are equal and inductance values of the first magnetic element, the first inductors and the second inductors are equal, such that resonant frequencies of the power converter in each operation loop of each operation interval in one operation cycle are the same, and thus the power converter operates in a resonant state.

17. The power converter of claim 13, wherein switching states of the first to the fourth power switches and each of the fifth and the sixth power switches are controlled, such that the output voltage is equal to 1/(2*N) of the input voltage.

18. The power converter of claim 13, wherein duty ratios of the first to the fourth power switches, the first N fifth power switches and the first N sixth power switches are respectively equal to 1/N.

19. The power converter of claim 13, wherein:
a) switching states of a 1^{st} fifth power switch, the second power switch and the fourth power switch are the same, switching states of a (2N−n+1)th fifth power switch and a nth fifth power switch are complementary;
b) switching states of a 1^{st} sixth power switch, the first power switch and the third power switch are the same, switching states of a (2N−n+1)th sixth power switch and a nth sixth power switch are complementary; and
c) the first power switch and the second power switch are under phase-shifted control, and a phase difference between turn-on moments of the first and second power switches is 360°/N, n is less than or equal to N.

20. The power converter of claim 13, wherein:
a) 1^{st} to Nth fifth power switches are under phase-shifted control, such that a phase difference between turn-on moments of every two adjacent power switches in the 1^{st} to the Nth fifth power switches is 360°/N; and
b) 1^{st} to Nth sixth power switches are under phase-shifted control, such that a phase difference between turn-on moments of every two adjacent power switches in the 1^{st} to the Nth sixth power switches is 360°/N.
